(19) United States
(12) Patent Application Publication
(10) Pub. No.: US 2016/0259694 A1
(43) Pub. Date: Sep. 8, 2016

(54) METHOD AND DEVICE FOR ORGANIZING AND RESTORING FILE INDEXESES

(71) Applicant: STREAMAX TECHNOLOGY CO., LTD, Shenzhen (CN)

(72) Inventors: Kaiming HUANG, Shenzhen (CN); Jiye SUN, Shenzhen (CN); Xidian WANG, Shenzhen (CN)

(21) Appl. No.: 15/030,840

(22) PCT Filed: Dec. 1, 2014
(86) PCT No.: PCT/CN2014/092664

§ 371 Date: Apr. 20, 2016

(30) Foreign Application Priority Data
Sep. 28, 2014 (CN) 201410510095.1

(51) Int. Cl. G06F 11/14; G06F 17/30

(52) U.S. Cl. CPC G06F 11/1458; G06F 17/30504; G06F 11/1471; G06F 17/30336; G06F 2201/80

(57) ABSTRACT

The present invention provides a method and device for organizing and restoring file indexes, which belongs to a technical field of data storing methods. In the present invention, a circular bidirectional linked list is constituted by all files in a storage medium firstly, wherein the bidirectional linked list comprises a forward linked list and a backward linked list; the indexes of all files are stored in an index information set, and each file is provided therein with a backup of its corresponding index; afterwards, in the process of accessing of a file, if the index of the file in the index information set doesn't match with the backup of the index of the file, the bidirectional linked list is restored; finally, the indexes of all files are re-established according to the restored bidirectional linked list. By using the method and device for organizing and restoring file index of the present invention, an efficiency of file index reestablishment can be improved.

### THCHNICAL FIELD

The present application relates to the technical field of data storing methods, and more particularly, relates to a method and device for organizing and restoring file indexes.

### BACKGROUND

A file system implements file management based on indexes, and positions files using the indexes; losing of a file index will result in that the file system can't access a file corresponding to the file index any more, which is equal to losing of the file.

In the operation process of the file system, index data is updated frequently. If environment is not stable, for example, in a vehicle-mounted environment, or in the case of a jitter, an electromagnetic oscillation or a power outage occurring frequently, an interrupt of index updating process or data interference in data transmission is prone to happen. In these environments, data integrity of the indexes is easy to be damaged.

In one aspect, damages of the indexes may lead to losing of existing files; in another aspect, when an upper layer application reads an abnormal index value, the upper layer application may stop working due to the absence of a corresponding process flow, for example, in a file system applied in a video surveillance field, damaged indexes must be restored in time and fast, such that an uninterrupted video recording and videos without losing can be achieved.

Existing file systems usually adopt an index organization mechanism of a directory hierarchy result, which has a complicated structure and is difficult to be re-established. When a damaged index occurs, restoring of the damaged index can only be accomplished by traversing the files in a whole hard disk with the aid of an offline tool to re-establish the indexes, and thus fast online self-restoring can't be achieved.

### BRIEF SUMMARY

The present application provides a method and device for organizing and restoring system file indexes, which improves the efficiency of restoring file indexes.

In one aspect, the present invention provides a method for restoring and organizing file indexes, comprising:

using all files in a storage medium to constitute a bidirectional linked list, the bidirectional linked list comprises a forward linked list and a backward linked list;

storing indexes of all files in an index information set, and in each file, providing a backup of an index corresponding to the file;

in the process of accessing of a file, if an index of a file in the index information set doesn't match with a backup of the index of the file, restoring the bidirectional index;

re-establishing the indexes of all files according to the restored bidirectional linked list.

In another aspect, the present invention provides a device for restoring and organizing file indexes, comprising:

a constituting module configured for using all files in a storage medium to constitute a bidirectional linked list, the bidirectional linked list comprises a forward linked list and a backward linked list;

a storing and backup module configured for storing indexes of all files in an index information set, and in each file, providing a backup of an index corresponding to the file;

a restoring module configured for restoring the bidirectional index if an index of a file in the index information set doesn't match with a backup index of the file in the process of accessing of the file;

a re-establishing module configured for re-establishing the indexes of all files according to a restored bidirectional linked list.

### Advantageous Effects

In the present invention, a circular bidirectional linked list is constituted by all files in a storage medium firstly, the bidirectional linked list comprises the forward linked list and the backward linked list, wherein the indexes of all files are stored in the index information set, and each file is provided therein with a backup of its corresponding index; afterwards, in the process of accessing of a file, if the index of the file in the index information set doesn't match with the backup of the index of the file, the bidirectional linked list is restored; finally, the indexes of all files are re-established according to the restored bidirectional linked list. Therefore, an efficiency of file index reestablishment can be improved.

### BRIEF DESCRIPTION OF THE DRAWINGS

In order to explain the embodiments of the present invention more clearly, a brief introduction regarding the accompanying drawings that need to be used for describing the embodiments is given below; it is obvious that the accompanying drawings described as follows are only some embodiments of the present invention, for those skilled in the art, other drawings can also be obtained according to the current drawings on the premise of paying no creative labor.

FIG. 1 illustrates one flow chart of a method for organizing and restoring system file indexes provided by a first embodiment of the present invention;

FIG. 2 illustrates one flow chart of a method for organizing and restoring system file indexes provided by a second embodiment of the present invention;

FIG. 3 illustrates a schematic view of constituting a bidirectional linked list by using files relating to the method for organizing and restoring file indexes provided by the second embodiment of the present invention;

FIG. 4 illustrates a schematic view of constituting a backward linked list by using files relating to the method for organizing and restoring file indexes provided by the second embodiment of the present invention;

FIG. 5 illustrates a schematic view of constituting a forward linked list by using files relating to the method for organizing and restoring file indexes provided by the second embodiment of the present invention;

FIG. 6 illustrates a schematic view of storing indexes of all files, and in each file, providing a backup of an index corresponding to the file relating to the method for organizing and restoring file indexes provided by the second embodiment of the present invention;

FIG. 7 illustrates a schematic structural diagram of a device for organizing and restoring file indexes provided by a third embodiment of the present invention.

FIG. 8 illustrates a schematic structural diagram of a restoring module of the device for organizing and restoring file indexes provided by the third embodiment of the present invention.

### DETAILED DESCRIPTION OF THE PREFERRED EMBODIMENT

In order to make the purpose, the technical features, and the advantages of the present invention be clearer, embodiments of the present invention will be further described in detail hereafter with reference to the accompanying drawings.

### Embodiment I

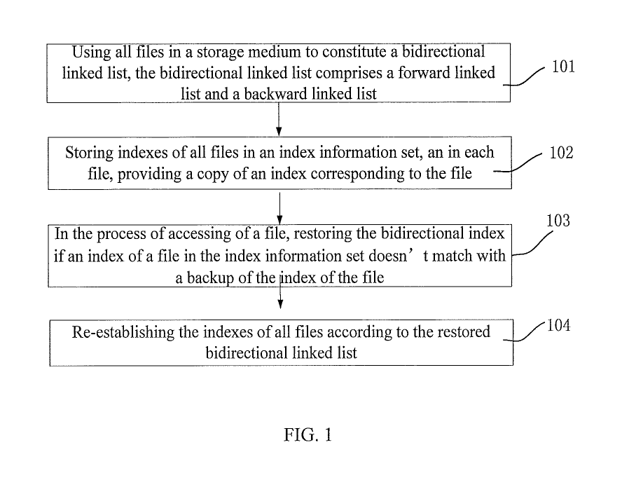

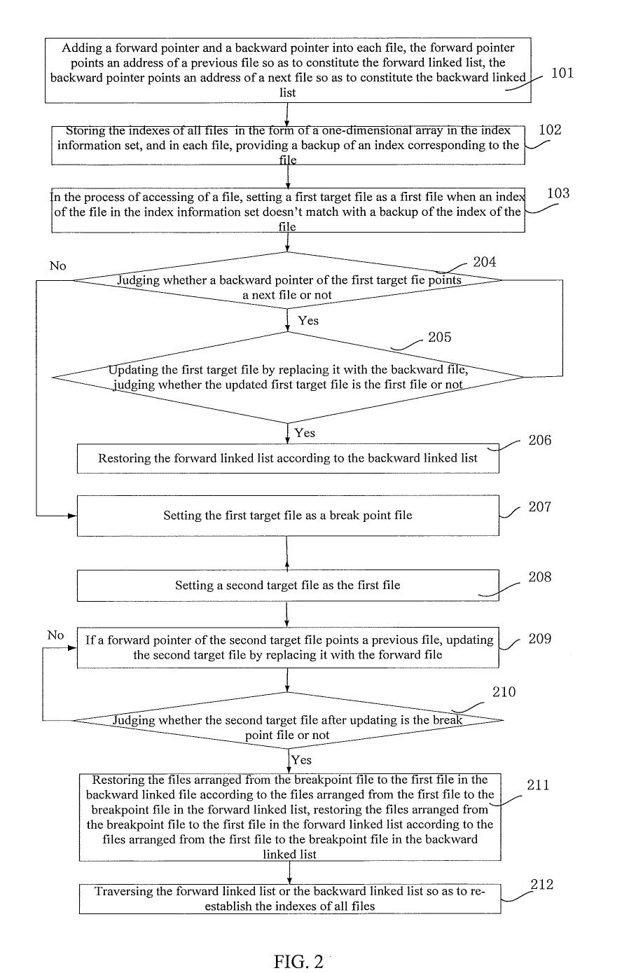

A first embodiment of the present invention provides a method for organizing and restoring file indexes. Please refer to FIG. 1, the method for organizing and restoring file indexes comprises the following steps:

step 101, using all files in a storage medium to constitute a bidirectional linked list, wherein the bidirectional linked list comprises a forward linked list and a backward linked list.

Step 102, storing indexes of all files in an index information set, and in each file, providing a backup of an index corresponding to the file.

Step 103, in the process of accessing of a file, restoring the bidirectional linked list when an index of the file in the index information set doesn't match with the backup of the index of the file.

Step 104, re-establishing the indexes of all files according to the restored bidirectional linked list.

For example, there are five files in a hard disk, a bidirectional linked list is constituted by the five files, the bidirectional linked list comprises a forward linked list and a backward linked list; indexes of the five files are stored in an index information set, a backup corresponding to each file is stored in the file; in the process of accessing file 2, if an index of the file 2 in the index information set doesn't match with a backup of the file 2, the bidirectional linked list is restored, and the indexes of the five files are re-established according to the restored bidirectional linked list.

In the present embodiment, a circular bidirectional linked list is constituted by all files in a storage medium firstly, the bidirectional linked list comprises the forward linked list and the backward linked list, wherein the indexes of all files are stored in the index information set, and each file is provided therein with a backup of its corresponding index; afterwards, in the process of accessing of a file, if the index of the file in the index information set doesn't match with the backup of the index of the file, the bidirectional linked list is restored; fmally, the indexes of all files are re-established according to the restored bidirectional linked list. Therefore, an efficiency of file index reestablishment can be improved.

### Embodiment II

A second embodiment of the present invention provides a method for organizing and restoring file indexes, the method for organizing and restoring file indexes comprises the following steps:

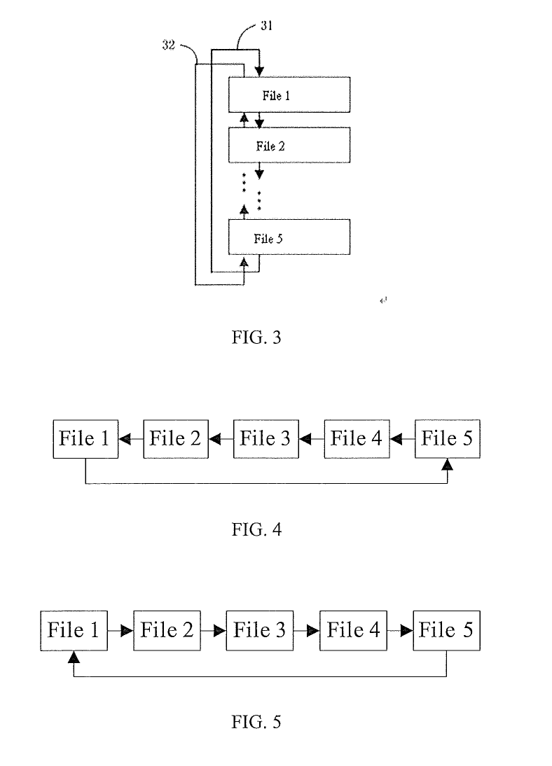

step 201, adding a forward pointer and backward pointer in each file, the forward pointer points an address of a previous file so as to constitute a forward linked list, the backward pointer points to an address of a next file so as to constitute a backward linked list. As shown in FIG. 3, both aforesaid forward linked list 32 and aforesaid backward linked list 31 are loop-shaped; as shown in FIG. 4, a previous file of the first file (a file 1) in the backward linked list is the last file (a file 5), the backward linked list points from the file 5 to a file 4, from the file 4 to a file 3, from the file 3 to a file 3, from the file 2 to the file 1, and from the file 1 to the file 5 again so as to form a loop-shaped linked list. As shown in FIG. 5, in the forward linked list, a next file of the last file (file 5) in the forward linked list is the first file (file 1), the forward linked list points from the file 1 to the file 2, from the file 2 to the file 3, from the file 3 to the file 4, from the file 4 to the file 5, and from the file 5 to the file 1 again so as to form another loop-shaped linked list.

Step 202, storing the indexes of all files in the form of a one-dimensional array in the index information set, and in each file, providing a backup of an index corresponding to the file.

Step 203, in the process of accessing of a file, if an index of the file in the index information set doesn't match with a copy of the index of the file, setting a first target file as a first file.

Step 204, judging whether a backward pointer of the first file points a next file thereof or not, if yes, executing a step 205; if no, executing a step 207.

Step 205, updating the first target file into the next file, judging whether the updated first target file is the first file or not; if yes, executing a step 206, if no, executing the step 204.

Step 206, restoring the forward link list according to the backward linked list, then stopping the method.

Step 207, regarding the first target file as a breakup file.

Step 208, setting a second target file as the first file.

Step 209, if a forward pointer of the second target file points a previous file thereof, replacing the second target file with the previous file.

Step 210, judging whether the updated second target file is the break point file, if yes, executing a step 211, if no, executing the step 209.

Step 211, restoring the files arranged from the breakpoint file to the first file in the backward linked file according to the files arranged from the first file to the breakpoint file in the forward linked list, restoring the files arranged from the breakpoint file to the first file in the forward linked list according to the files arranged from the first file to the breakpoint file in the backward linked list.

Step 212, traversing the forward linked list or the backward linked list so as to re-establish the indexes of all files.

Restoring of the bidirectional linked list lasts from the process 203 to the process 211; by traversing backwardly along the forward linked list and starting from the first file of the forward linked list to search for break point files, then traversing forwardly along the backward linked list and starting from the first file of the backward linked list until a break point file is found, and finally, restoring the files arranged from the breakpoint file to the first file in the backward linked file according to the files arranged from the first file to the breakpoint file in the forward linked list, and restoring the files arranged from the breakpoint file to the first file in the forward linked list according to the files arranged from the first file to the breakpoint file in the backward linked list, thereby completing restoring of the bidirectional linked list.

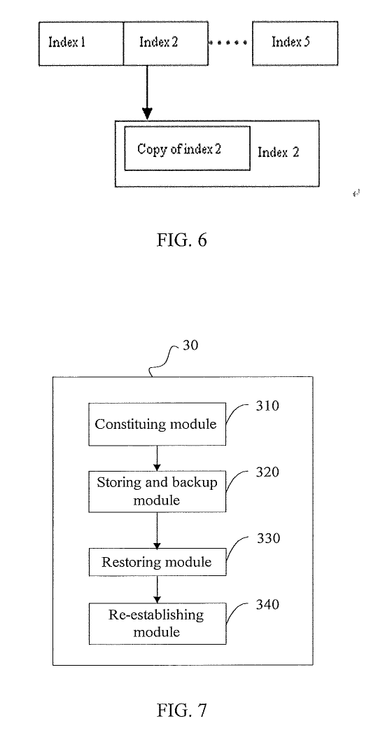

For example, there are five files in a hard disk, a forward pointer and a next file is added into each file, the backward pointer points an address of a next file so as to constitute the backward linked list, as shown in FIG. 4; the forward pointer points an address of a previous file so as to constitute the forward linked list, as shown in FIG. 5. Indexes of the five files in the form of a one-dimensional array are stored into the index information set, and in each file a backup of a corresponding index is stored. As shown in FIG. 6, in the process of accessing a file (file 2), if an index of the file 2 in the index information set doesn't match with a backup of the index of the file 2, setting the first target file as the file 1; judging whether a backward pointer of the first target file (file 1) points a next file (file 2) or not; if aforesaid judgment result is yes, replacing the first target file with the next file (file 2), and judging whether the updated first target file (file 2) is the first file (file 1) or not; if aforesaid judgment result is no, judging whether a backward pointer of the first target file (file 2) points another next file (file 3) or not; if aforesaid judgment result is no, setting the first target file (file 2) as the break point file; further setting the second target file as the first file (file 1) again, if a forward pointer of the second target file (file 1) points a previous file (file 5), replacing the second target file with the previous file (file 5); judging whether the second file is the break point file (file 2) or not, if aforesaid judgment result is no, repeatedly executing a procedure of if the forward pointer of the second target file points a previous file thereof, replacing the second target file with the previous file, until the second target file is the file 2 and a precondition that the second target file is not the break point file (file 2) isn't met, the files arranged from the breakpoint file (file 2) to the first file (file 1) in the backward linked file are restored according to the files arranged from the first file (file 1) to the breakpoint file (file 2) in the forward linked list, the files arranged from the breakpoint file (file 2) to the first file (file 1) in the forward linked list are restored according to the files arranged from the first file (file 1) to the breakpoint file (file 2) in the backward linked list; the forward linked list or the backward linked list are traversed so as to re-establish the indexes of the five files.

In the present embodiment, a circular bidirectional linked list is constituted by all files in a storage medium firstly, the bidirectional linked list comprises the forward linked list and the backward linked list, the indexes of all files are stored in the index information set, and each file is provided with a backup of its corresponding index; afterwards, in the process of accessing of a file, when the index of the file in the index information set doesn't match with the backup of the index of the file, the forward linked list is traversed from the first file thereof until the break point file is found, afterwards, the bidirectional linked list is restored by traversing the backward linked list from the first file thereof to the break point file; finally, the indexes of all files are re-established by traversing the forward linked list or the backward linked list, therefore, an efficiency of file index reestablishment can be improved.

### Embodiment III

A third embodiment of the present invention provides a device 30 for organizing and restoring file indexes, as shown in FIG. 7, the device 30 for organizing and restoring file index comprises a constituting module 310, a storing and backup module 320, a restoring module 330 and a re-establishing module 340.

The constituting module 310 is configured for constituting a bidirectional linked list using all files in a storage medium, wherein the bidirectional linked list comprises a forward linked list and a backward linked list;

the storing and backup module 320 is configured for storing indexes of all files in an index information set, and in each file, providing a backup of an index corresponding to the file;

the restoring module 330 is configured for restoring the bidirectional index if an index of a file in the index information set doesn't match with a backup index of the file in the process of accessing of a file;

the re-establishing module 340 is configured for re-establishing indexes of all files according to a restored bidirectional linked list.

In particular, the constituting module makes up a bidirectional linked list using all files in a hard disk is:

adding a forward pointer and a backward pointer in each file, the forward pointer points an address of a previous file so as to constitute the forward linked list, the backward pointer points an address of a next file so as to constitute the backward linked list, a previous file of a first file is a last file, a next file of the last file is the first file.

In particular, the step that the storing and backup module 320 stores indexes of all files in the index information set is:

storing indexes of all files in the form of a one-dimensional array into the index information set.

In particular, the step that the re-establishing module 340 re-establishes indexes of all files according to the restored bidirectional linked list is:

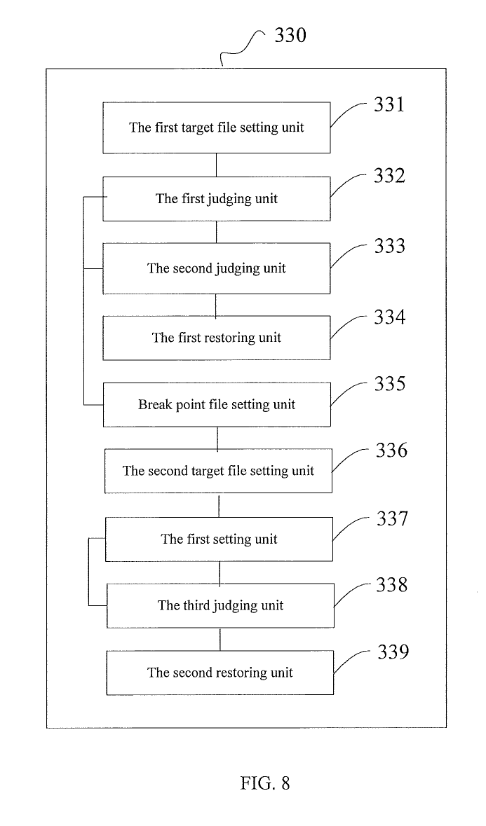

traversing the forward linked list or the backward linked list so as to re-establish the indexes of all files.

Wherein, as shown in FIG. 8, the restoring module comprises a first target file setting unit 331, a first judging unit 332, a second judging unit 333, a first restoring unit 334, a breakpoint file setting unit 335, a second target file setting unit 336, a first setting nit 337, a third judging unit 338, and a second restoring unit 339.

The first target file setting unit 331 is configured for setting a first target file as a first file;

the first judging unit 332 is configured for judging whether a backward pointer of the first target file points a next file or not;

the second judging unit 333 is configured for updating the first target file by replacing it with the next file, and judging whether the updated first target file is the first file or not;

the first restoring unit 334 is configured for restoring the forward linked list according to the backward linked list;

the breakpoint file setting unit 335 is configured for regarding the first target file as a breakpoint file;

the second target file setting unit 336 configured for setting a second target file as the first file;

the first setting unit 337 is configured for updating the second target file by replacing it with the previous file if a forward pointer of the second target file points a previous file;

the third judging unit 338 configured for judging whether the second target file after updating is the breakpoint file or not;

the second restoring unit 339 is configured for restoring the files arranged from the breakpoint file to the first file in the backward linked file according to the files arranged from the first file to the breakpoint file in the forward linked list, and restoring the files arranged from the breakpoint file to the first file in the forward linked list according to the files arranged from the first file to the breakpoint file in the backward linked list.

In the present embodiment, a circular bidirectional linked list is constituted by all files in a storage medium firstly, the bidirectional linked list comprises the forward linked list and the backward linked list, wherein the indexes of all files are stored in the index information set, and each file is provided therein with a backup of its corresponding index; afterwards, in the process of accessing of a file, if the index of the file in the index information set doesn't match with the backup of the index of the file, the bidirectional linked list is restored; finally, the indexes of all files are re-established according to the restored bidirectional linked list. Therefore, an efficiency of file index reestablishment can be improved.

Serial numbers of aforesaid embodiments of the present invention are used for description merely, rather than representing superiority and inferiority of the embodiments.

Those skilled in the art should understand that a part or all of the procedures for implementing the aforementioned embodiments can be accomplished by hardware, or by using a program to instruct relevant hardware, the program can be stored in a computer readable storage medium, the above-mentioned storage medium mentioned can be a ROM (Read Only Memory), a magnetic disk, an optical disk, and so on.

The aforementioned embodiments are only preferred embodiments of the present invention, and should not be regarded as being any limitation to the present invention. Any modification, equivalent replacement, improvement, and so on, which are made within the spirit and the principle of the present invention, should be included within the protection scope of the present invention.

1. A method for organizing and restoring file indexes, comprising :
using all files in a storage medium to constitute a bidirectional linked list, wherein the bidirectional linked list comprises a forward linked list and a backward linked list;
storing indexes of all files in an index information set, and in each file, providing a backup of an index corresponding to the file;
in the process of accessing of a file, if an index of a file in the index information set doesn't match with a backup of the index of the file, restoring the bidirectional linked list;
re-establishing the indexes of all files according to the restored bidirectional linked list.

2. The method according to claim 1, wherein, in particular, the step of using all files in the hard disk to constitute a bidirectional linked list is:
adding a forward pointer and a backward pointer into each file, wherein the forward pointer points an address of a previous file so as to constitute the forward linked list, the backward pointer points an address of a next file so as to constitute the backward linked list.

3. The method according to claim 1, wherein, in particular, the step of storing indexes of all files in the index information set is:
storing the indexes of all files in the form of a one-dimensional array in the index information set.

4. The method according to claim 1, wherein the step of restoring the bidirectional linked list comprises the following sub-steps:
A. setting a first target file as a first file;
B. judging whether a backward pointer of the first target file points a next file or not, if yes, executing a sub-step C; if no, executing a sub-step E;
C. updating the first target file into the next file, judging whether the updated first target file is the first file or not, if yes, executing a sub-step D; if no, executing the sub-step B;
D. restoring the forward linked list according to the backward linked list, and stop the step;
E. regarding the first target file as a breakpoint file;
F. setting a second target file as the first file;
G. if a forward pointer of the second target file points a previous file, updating the second target file into the previous file;
H. judging whether the updated second target file is the breakpoint file or not, if yes, executing a sub-step I; if no, executing the sub-step G;
I. restoring the files arranged from the breakpoint file to the first file in the backward linked list according to the files arranged from the first file to the breakpoint file in the forward linked list, restoring the files arranged from the breakpoint file to the first file in the forward linked list according to the files arranged from the first file to the breakpoint file in the backward linked list.

5. The method according to claim 4, wherein, in particular, the step of re-establishing the indexes of all files according to the restored bidirectional linked list is:
traversing the forward linked list or the backward linked list so as to re-establish the indexes of all files in the index information set.

6. A device for organizing and restoring file indexes, comprising:
a constituting module configured for using all files in a storage medium to constitute a bidirectional linked list, the bidirectional linked list comprises a forward linked list and a backward linked list;
a storing and backup module configured for storing indexes of all files in an index information set, and in each file, providing a backup of an index corresponding to the file;
a restoring module configured for restoring the bidirectional index if an index of a file in the index information set doesn't match with a backup index of the file in the process of accessing of the file;
a re-establishing module configured for re-establishing the indexes of all files according to a restored bidirectional linked list.

7. The device according to claim 6, wherein the constituting module constitutes a bidirectional linked list for all files in a hard disk is:
adding a forward pointer and a backward pointer in each file, the forward pointer points an address of a previous file so as to constitute the forward linked list, the backward pointer points an address of a next file so as to constitute the backward linked list, a previous file of a first file is a last file, a next file of the last file is the first file.

8. The device according to claim 6, wherein the storing and backup module stores indexes of all files in the index information set is:
storing the indexes of all files in the index information set in the form of a one-dimensional array.

9. The device according to claim 6, wherein the restoring module comprises:
a first target file setting unit configured for setting a first target file as a first file;
a first judging unit configured for judging whether a backward pointer of the first target file points a next file or not;
a second judging unit configured for updating the first target file by replacing it with the next file, and judging whether the first target file after updating is the first file or not;
a first restoring unit configured for restoring the forward linked list according to the backward linked list;
a breakpoint file setting unit configured for regarding the first target file as a breakpoint file;
a second target file setting unit configured for setting a second target file as the first file;
a first setting unit configured for updating the second target file by replacing it with the previous file if a forward pointer of the second target file points a previous file;
a third judging unit configured for judging whether the second target file after updating is the breakpoint file or not;
a second restoring unit configured for restoring the files arranged from the breakpoint file to the first file in the backward linked file according to the files arranged from the first file to the breakpoint file in the forward linked list, and restoring the files arranged from the breakpoint file to the first file in the forward linked list according to the files arranged from the first file to the breakpoint file in the backward linked list.

10. The device according to claim 6, wherein the re-establishing module re-establishes the indexes of all files according to the restored bidirectional linked list is:
traversing the forward linked list or the backward linked list so as to re-establish the indexes of all files.
